(19) United States
(12) Patent Application Publication
(10) Pub. No.: US 2012/0060039 A1
(43) Pub. Date: Mar. 8, 2012

(54) Code Download and Firewall for Embedded Secure Application

(75) Inventor: Maxime Leclercq, Encinitas, CA (US)

(73) Assignee: MaxLinear, Inc., Carlsbad, CA (US)

(21) Appl. No.: 13/041,256

(22) Filed: Mar. 4, 2011

Related U.S. Application Data
(60) Provisional application No. 61/372,390, filed on Aug. 10, 2010.
(60) Provisional application No. 61/319,198, filed on Mar. 30, 2010.
(60) Provisional application No. 61/318,774, filed on Mar. 29, 2010.
(60) Provisional application No. 61/318,220, filed on Mar. 26, 2010.
(60) Provisional application No. 61/311,153, filed on Mar. 5, 2010.

(51) Int. Cl. H04L 9/00; G06F 12/14

(52) U.S. Cl. 713/189; 711/E12.103

(57) ABSTRACT

A device includes a demodulator for receiving an encrypted content, an interface unit communicatively coupled to an external memory, and a hardware unit coupled to the demodulator and configured to enable the demodulator to decrypt the received content. The hardware unit includes a processing unit, a ROM having a boot code causing the device to fetch data from the external memory, a RAM for storing the fetched data, multiple non-volatile memory registers or fuse banks, and a mechanism configured to write the stored data to an external storage device in response to a backup event. The data may be encrypted using an encryption key prior to being written to the external storage device. The interface unit may include a wired or wireless communication link. The boot code includes executable instructions performing a series of validations. The device disables the executable instructions in the event of a validation failure.

### CROSS-REFERENCES TO RELATED APPLICATIONS

The present application claims benefit under 35 USC 119(e) of the following US applications, the contents of all of which are incorporated herein by reference in their entirety:
U.S. application No. 61/311,153, filed Mar. 5, 2010, entitled “Code Download and Firewall for Embedded Secure Application”;
U.S. application No. 61/318,220, filed Mar. 26, 2010, entitled “Firmware Authentication and Deciphering for Secure TV Receiver”;
U.S. application No. 61/318,774, filed Mar. 29, 2010, entitled “Generation of SW Encryption Key During Silicon Manufacturing Process”;
U.S. application No. 61/319,198, filed Mar. 30, 2010, entitled “Control Word Obfuscation in Secure TV Receiver”; and
U.S. application No. 61/372,390, filed Aug. 10, 2010, entitled “Control Word Obfuscation in Secure TV Receiver”.

The present application is related to and incorporates by reference the entire contents of the following US applications:
U.S. application Ser. No. 13/021,178, filed Feb. 4, 2011, entitled “Conditional Access Integration in a SOC for Mobile TV Applications”; and
U.S. application Ser. No. 13/026,000, filed Feb. 11, 2011, entitled “RAM Based Security Element for Embedded Applications”.

### BACKGROUND OF THE INVENTION

Embodiments of the present invention relate to information processing. More particularly, embodiments of the present invention relate to a system, device and method having a RAM based security element for storing data fetched from an external memory and a ROM-based boot code for authenticating the stored data. The boot code authenticates the stored data by running a boot loader process including a series of security verifications. Embodiment of the present invention may apply to conditional access systems for digital broadcast television.

There are several well-known digital radio and digital TV broadcast standards. In Europe, the digital radio broadcast is the DAB (Digital Audio Broadcasting) adopted by the ITU-R standardization body and by ETSI. The digital TV standard is DVB (Digital Video Broadcasting) in Europe, ATSC (Advanced Television Systems Committee) in the U.S., and ISDB (Integrated Services Digital Broadcasting) in Japan and South America. In addition to these standards, there are also mobile TV standards which relate to the reception of TV on handheld devices such as mobile phones or the like. Some well-known mobile TV standards are DVB-H (Digital Video Broadcasting-Handheld), CMMB (China), DMB (Digital Multimedia Broadcasting), and Mediaflo.

In most digital TV broadcasting services, the service providers scramble and encrypt the transmitted data streams to protect the broadcasted content and require their customers or users to install “security protection” mechanisms to decrypt and descramble the content. Security protection mechanisms such as digital rights management enable users to store content. Conditional access systems are other security protection mechanisms that allow users to access and view content but may or may not record the viewed content.

In a typical pay-TV system, the conditional access software runs on a dedicated secure element implementing robust mechanisms so as to prevent a malicious entity (“hacker”) from gaining access to the broadcast system secret to decipher the TV content. The CA instruction code and keys provisioned by the CA provider adapted to ensure security are typically stored in a non-volatile memory, such as an EEPROM or Flash, which are relatively expensive and require a specifically tuned CMOS process and additional process steps for fabrication and testing.

FIG. 1 is a block diagram of a conventional TV receiver 100 performing conditional access (CA) functions. Receiver 100 includes a TV demodulator 110 coupled to a suitable antenna 105 for receiving broadcast content. Demodulator 110 is connected to a secure element 120. The connection can be a proprietary interface or a standard interface. Secure element 120 may be provided by the service provider and controls access to a broadcast service by descrambling an encrypted broadcast transmission. Secure element 120 may also hold service entitlement information controlled by the service provider. The service provider may communicate with the secure element using encrypted messages that carry descrambling keys and other service management information. Secure element 120 descrambles encrypted data streams received from the TV demodulator and provides the descrambled data streams to a video and audio decoder 130. A display 140 coupled to the video and audio decoder displays the decoded video and audio data streams. In general, secure element 120 may be provided in several forms and in multiple packaging options. For example, the secure element may be a dedicated surface mount device mounted on the receiver, a SIM card, a secure SD card, or a module. The secure element typically includes a crypto processor, a secure CPU, read-only memory (ROM), and electrical erasable and programmable ROM (EEPROM) or Flash, as shown in FIG. 1.

FIG. 2 is a block diagram of a conventional secure element 200 showing components incorporated in the secure element 120 of FIG. 1. Secure element 200 includes a demodulator interface 210 that establishes a physical and electrical connection with the demodulator 110. Typically, the physical and electrical connection is a proprietary hardware interface that enables a user to plug the secure element to the TV demodulator. Secure element 200 also includes a secure CPU 220 that is configured to decrypt messages or data streams that are transmitted by the service providers. Secure element 200 further includes a plurality of hardware accelerators 230-1, 230-2, . . . , 230-n that assist the secure CPU for descrambling data streams and decode specific messages from the service provider. Secure element 200 additionally includes read-only memory 240 (ROM) and EEPROM/Flash memory 250. The ROM and EEPROM/Flash memory are programmed by the conditional access (CA) provider and contain CA firmware and decryption keys. When enabled by the user, CPU 220 executes program code stored in ROM and EEPROM/Flash memory and starts processing data streams received through the demodulator interface 210.

As shown in FIG. 1, the secure element 120 may include two physical interfaces, one for receiving encrypted data streams and the other one for sending decrypted data streams back to the demodulator. Other physical interfaces may exist for facilitating communication between the secure element and the demodulator.

It can be seen that the conventional secure element has a hardware architecture that is inflexible and adds costs to service providers. Furthermore, conventional techniques do not appear to address the concerns of service providers, CA operators, and content owners, specifically, at the point where content leaves the secure element.

### BRIEF SUMMARY OF THE INVENTION

Embodiments of the present invention provide an integrated circuit that integrates functions (secure element) required to achieve security in a monolithic silicon device formed on the same substrate using a conventional CMOS process, e.g., a CMOS system-on-a-chip (SOC). In an embodiment, the integrated circuit includes a demodulator for receiving an encrypted content, an interface unit configured to communicate with an external memory, and a hardware unit that is communicative coupled to the demodulator and configured to enable the demodulator to decrypt the received content. The hardware unit includes a processing unit, a read-only access memory (ROM) having a boot code configured to cause the integrated circuit to fetch executable applications from the external memory, a random access memory (RAM) for storing the fetched executable applications, multiple non-volatile memory registers or fuse banks configured to store at least one unique identifier that is associated with the integrated circuit. The integrated circuit also includes multiple hardware accelerators. In a specific embodiment, one or more of the multiple non-volatile memory registers or fuse banks are burned or blown during the integrated circuit manufacturing process for storing the at least one unique identifier. In an embodiment, the external memory may be a Flash memory device. In an embodiment, the interface unit may include a wired connection enabling the integrated circuit to physically and electrically connect to the external memory via a connector. In another embodiment, the interface unit may include a wireless connection. In an embodiment, the boot code includes computer readable and executable instructions that perform multiple security verifications on the executable applications. In an embodiment, the at least one unique identifier comprises a digest boot root public key. In an embodiment, one or more of the executable applications may include a software vendor key, a software distribution key, and/or a software personalization key. In an embodiment, the multiple hardware accelerators may include cryptographic functions such as hashing algorithms, e.g., MD5, SHA, AES, 3DES, and/or RSA algorithms. In an embodiment, the integrated circuit may further include a firewall unit that allows the secure element to make connection to the external memory, but does not allow the external memory to initiate connection with the secure element. In an embodiment, the integrated circuit is a monolithic silicon device fabricated using conventional and widely available CMOS processes without additional process steps required for making EEPROM or Flash memory.

In an embodiment, the boot code includes instructions to cause the processing unit to authenticate the executable applications at run time, prior to initiating the executable applications. The integrated circuit disables the executable applications in the event that the authentication is not successful; that means, the executable applications may have been modified.

In an embodiment, the executable applications include a digital certificate having a digital signature and run-time configuration parameters and computer program data and codes. The integrated circuit programs the digital signature to one of the non-volatile memory (one-time programmable) registers, writes the run-time configuration parameters to the processing unit and causes the processing unit to authenticate the computer program data and codes. In an embodiment, the authentication of the computer program data and codes is performed by computing a hash value of the computer program data and codes and comparing the computed hash value using a digital signature mechanism. In an embodiment, a trusted party owning the computer program signs the hash value with an RSA private key. When loading the computer program data and codes during the lifetime of a product, the secure element regenerates the hash value and compare the regenerated hash value with the signature using the trusted party public key. If there is a match, the compute program data and codes are considered to be authentic.

Embodiments of the present invention also disclose a CMOS device that can be fabricated using standard CMOS processes without the additional process steps and testing procedures required by on-chip EEPROM and/or Flash memory units. The CMOS device includes an interface module for retrieving secure data from a memory that is external to the CMOS device. The CMOS device also includes a random access memory (RAM) unit for storing the retrieved secure data and a read-only memory (ROM) unit having a boot code that is configured to cause the CMOS device to authenticate the stored secure data based on a boot loader process that may include a series of validations. In an embodiment, the series of validations may include a chain of trust validation, a boot certificate validation, a certificate binding validation, a firmware image validation, and a firmware image encryption and decryption. In an embodiment, the chain of trust validation may include performing a hashing function on a root public key contained in the secure data to obtain a hash value and validating the hash value against a digest boot root public key that is stored in a non-volatile memory register of the CMOS device. In an embodiment, the CMOS device includes a mechanism to flush the secure data stored in the RAM if the CMOS device fails to successfully complete the series of validation. In an embodiment, the CMOS device further include a mechanism configured to encrypt the secure data stored in the RAM and write the encrypted secure data to an external storage device in response to a backup event. In an embodiment, the CMOS device may include a firewall unit that allows the CMOS device to initiate a connection to an external device and fetch (download) data files from the external device, but does not allow the external device to generate connections in the reverse direction. In an embodiment, the interface module may include a wired or a wireless communication link.

A specific embodiment of the present invention discloses a method for authenticating data that is to be stored in a device having a secure random access memory unit and a read only memory unit, wherein the read only memory unit includes a boot code that causes the device to fetch the data from an external device. The method includes fetching the data from an external memory, storing the fetched data in the secure random access memory, and authenticating the stored data based on a series of validations, wherein the fetched data contains at least a root public key. In an embodiment, the series of validations may include at least one of a chain of trust validation, a boot certificate validation, a certificate binding validation, and a firmware image validation. In an embodiment, the chain of trust validation may include performing RSA algorithms on a plurality of data encryption codes that are embedded in the data to obtain a respective plurality of encryption keys and comparing the obtained respective plurality of encryption keys with a corresponding plurality of encryption keys that is stored in the data.

In an embodiment, the method further includes encrypting the stored data and writing out the encrypted data to an external storage device in response to a backup event. In another embodiment, the method may further include flushing the stored data in the event that the device fails to complete the authenticating process successfully.

### BRIEF DESCRIPTION OF THE DRAWINGS

FIG. 1 is a block diagram of a conventional TV receiver 100 performing conditional access (CA) functions;

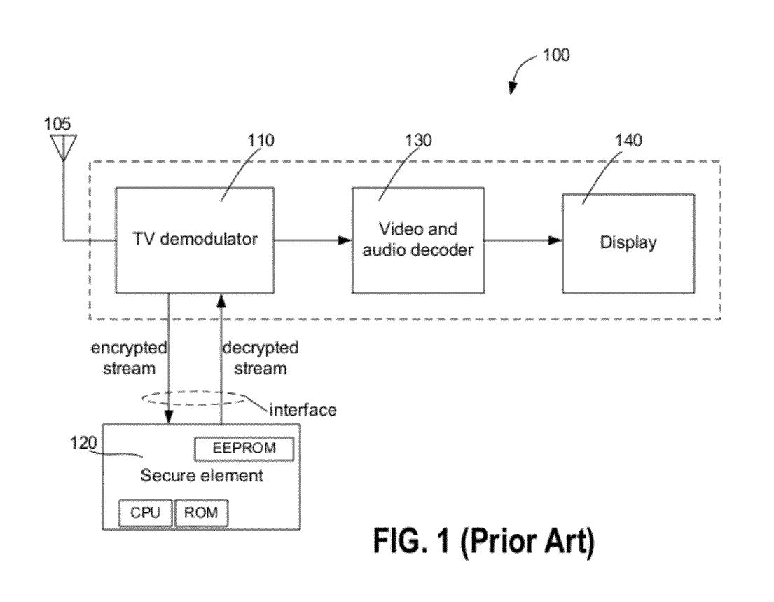

FIG. 2 is a block diagram of a conventional secure element 200 used in pay-TV applications;

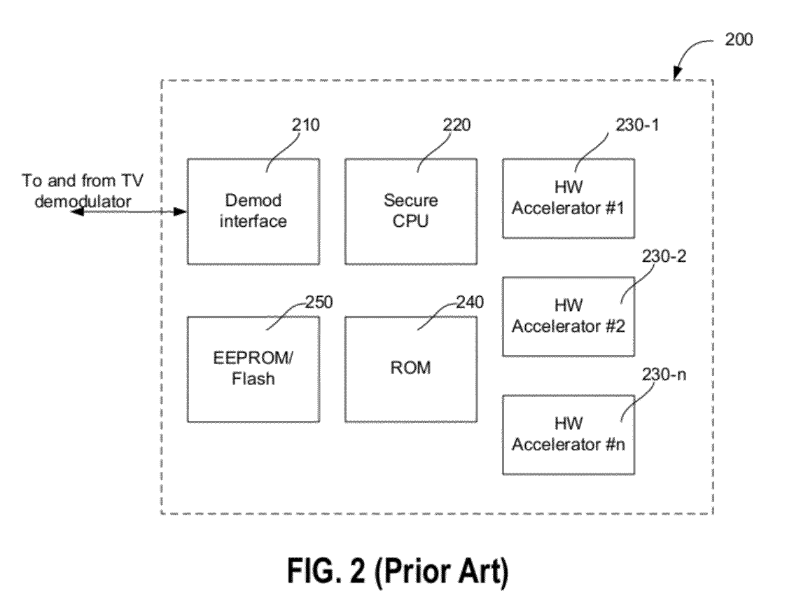

FIG. 3 is a simplified block diagram of an integrated conditional access sub-system in an SOC according to an embodiment of the present invention;

FIG. 4 is a simplified block diagram of an integrated secure element disposed in a demodulator SOC according to an embodiment of the present invention;

FIG. 5 is a simplified block diagram of an integrated secure element disposed in a demodulator SOC according to another embodiment of the present invention;

FIG. 6 is an exemplary process for generating an encryption key according to an embodiment of the present invention;

FIG. 7 is a simplified timing diagram illustrating a startup operation of a demodulator SOC according to an embodiment of the present invention;

FIG. 8 is an exemplary demodulator SOC that executes a data download operation from an external memory according to an embodiment of the present invention;

FIG. 9 is a simplified flow chart diagram illustrating a boot loader process according to an embodiment of the present invention;

FIG. 10 is an exemplary diagram illustrating a chain of trust validation having four-layer RSA public/private keys according to an embodiment of the present invention;

FIG. 11 is a simplified diagram illustrating a boot certificate validation according to an embodiment of the present invention;

FIG. 12 is a simplified diagram illustrating a certificate binding validation according to an embodiment of the present invention;

FIG. 13 is a simplified diagram illustrating a firmware image validation according to an embodiment of the present invention;

FIG. 14A is a simplified diagram illustrating a firmware image decryption (deciphering) according to an embodiment of the present invention;

FIG. 14B is a simplified diagram illustrating a firmware image decryption (deciphering) 1400B according to an alternative embodiment of the present invention;

FIG. 15 is a simplified diagram illustrating a one-step firmware decryption and authentication process according to an embodiment of the present invention;

FIG. 16 is a simplified diagram illustrating a firmware run-time authentication using hardware facilities provided by the secure element according to an embodiment of the present invention; and

FIG. 17 is a simplified block diagram of a demodulator SOC 1700 (e.g., a TV receiver SOC) illustrating an exemplary data backup operation according to an embodiment of the present invention.

### DETAILED DESCRIPTION OF THE INVENTION

Conditional access is used by TV broadcasters to generate revenue. To achieve this, security guidelines are used to protect the keys provisioned to the user and to guarantee that no hacker or malicious entity can crack the system and watch contents for free. These guidelines, also referred to as security requirements, define methods adapted to prevent misuse of the SOC (system-on-chip) device and its associated firmware, and furthermore to inhibit unauthorized access to secrets, such as keys, operating modes, etc. The SOC security framework described herein defines hardware (HW), software (SW), or a combination thereof (i.e., firmware) to achieve these objectives.

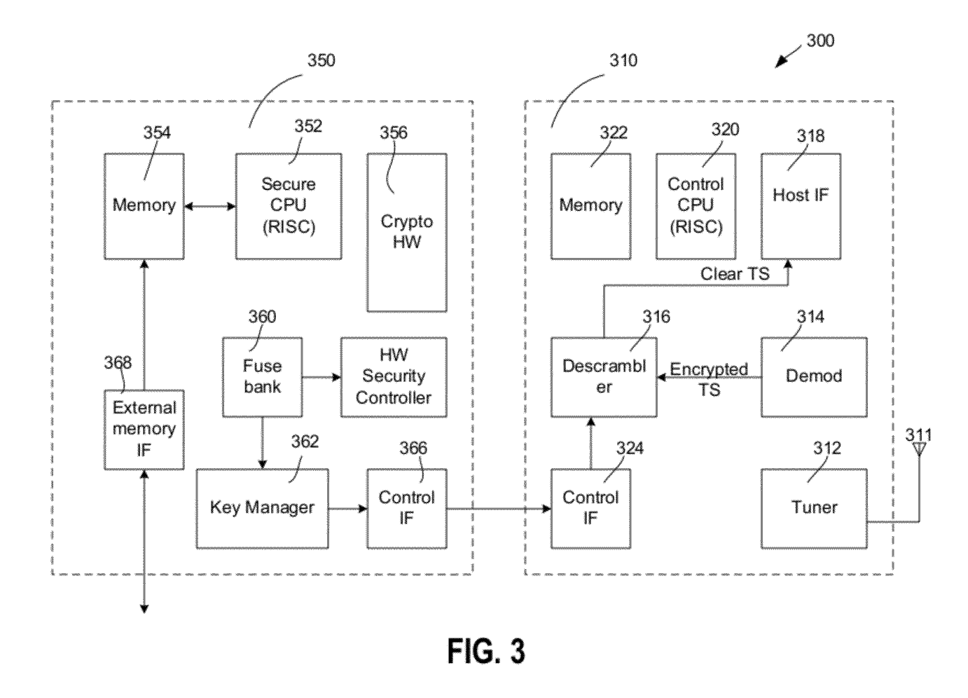

FIG. 3 is a simplified block diagram of a receiver system on a chip (SOC) 300 configured to perform tuning, demodulating, CA security, and the like, in accordance with an embodiment of the present invention. Receiver system 300 includes a digital broadcast receiver 310 that may be capable of receiving signals in a number of different frequency bands of interest and/or in a number of different formats. By way of example, receiver system 300 may be capable of receiving any one or more of the standards mentioned above or other suitable standards. In an exemplary embodiment, receiver system 300 also includes a conditional access security (CAS) sub-system 350.

Digital broadcast receiver 310 includes a tuner 312 that is connected to an antenna 311. Although an antenna is shown, tuner 312 may be connected to a number of antennas that is configured to suit different frequency bands of interest. The tuner frequency translates received signals and provide them to a demodulator 314, which may demodulate the frequency translated signals into multiple data streams (audio, video, text, and others). Receiver 310 also includes a descrambler 316 that descrambles the data streams (indicated as encrypted TS) and provides clear (i.e., descrambled) data streams (indicated as clear TS in FIG. 3) to a host via a host interface unit 318. Receiver 310 further includes a control processor 320 and a memory unit 322 that contains software (program code) to enable a user to select a service and to program the tuner to a desired frequency. In an embodiment, the memory 322 may include dynamic random memory and/or permanent memory such as read-only memory (ROM).

Receiver 310 also includes a control interface unit 324 that connects the digital broadcast receiver 310 with the conditional access security sub-system 350. As described in section above, control access is a protection of content required by content owners or service providers. Conventional access approaches use dedicated surface mount device such as Smartcard, SIM card, secure SD card or the like. In conventional approaches, CA instruction code and keys provisioned by CA providers adapted to ensure security are typically stored in a non-volatile memory, such as an EEPROM or Flash, which are relatively expensive and cannot be easily and cost effectively integrated using standard CMOS fabrication processes. A novel conditional access security (CAS) sub-system according to an embodiment of the present invention will be described in detail below.

Referring to FIG. 3, CAS sub-system 350 includes a secure processor 352 coupled to a memory unit 354. The secure CPU may be a RISC CPU configured to process various processing operations. CAS sub-system 350 further includes a crypto hardware 356 that, in an embodiment, includes suitable crypto logic, circuitry (e.g., hardware) for performing cryptographic operations. In a specific embodiment, crypto hardware 356 may be a crypto processor configure to perform cryptographic functions such as processing digital signature, key management, identifying public keys and others due to the secure access requirements. During the manufacturing process, cryptographic hardware may generate a unique crypto ID (identity) for the receiver SOC 300 and a unique encryption key. CAS sub-system also includes a fuse bank 360. In an embodiment, fuse bank 360 may include electrically programmable fuses on the chip. In an embodiment, the fuse bank may contain an array of electrically programmable registers, each having a number of bits. The bits can be programmed during the manufacturing process or later by the service provider as the device is shipped to the user. In an embodiment, corresponding bits of the fuse bank are burned or blown according to the value of the unique device ID and a certificate key. In a specific embodiment, memory unit 354 includes random access memory and read-only memory. In contrast to conventional techniques, memory unit 354 does not includes EEPROM and/or Flash memory to facilitate the integration process and to minimize cost by using conventional (i.e., standard) CMOS process.

In an embodiment, the receiver SOC 300 includes an external memory interface 368 configured to interface with an external memory. Although the external memory interface 368 is shown to be located in the CAS sub-system 350, it can be located in any part of the receiver SOC as further disclosed below. In an embodiment, the external memory interface 368 can include a SD memory card slot, a multimedia card (MMC), a micro SD card slot, a mini SDHC, a microSDHC, a Memory Stick slot, a PCMCIA interface, a USB interface, a serial or a parallel interface, and others. The external memory can be a commercial off-the-shelf Flash memory in a specific embodiment.

In accordance with embodiments of the present invention, the conditional access (CA) software code is stored in a random access memory (RAM). The CA software is dynamically downloaded from an external non-volatile flash memory via the external memory interface 368 to the RAM during the power cycle of the security sub-system. However, because the external flash storing the CA software is outside the security perimeter it must first be authenticated and checked for any malicious alteration (such as bypass of the security function that could be inserted by a hacker). The secure sub-system implements a protocol to authenticate the firmware using a public key algorithm and digital certificate provisioned during manufacturing.

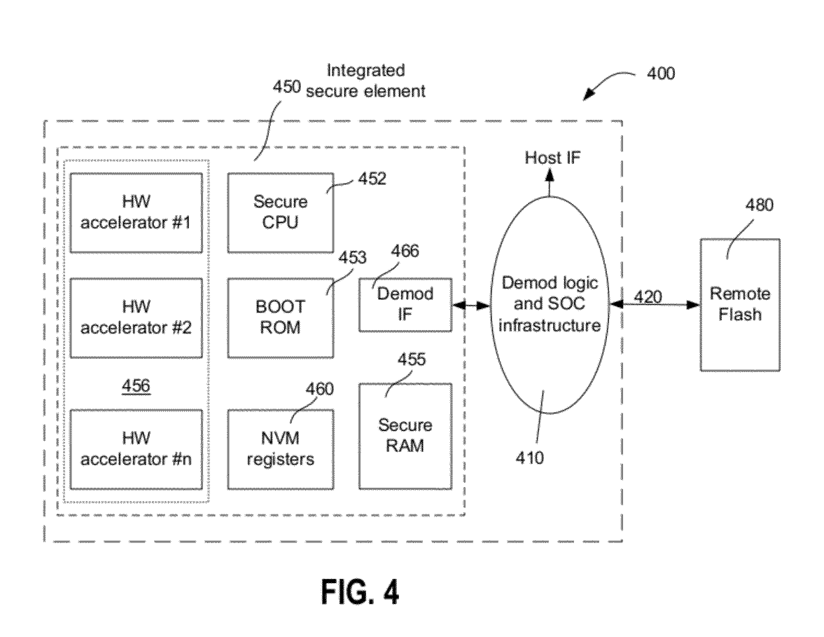

FIG. 4 is a block diagram of a demodulator SOC 400 including a demodulation logic 410 coupled to a remote memory device 480 (e.g., Flash memory) and an integrated secure element 450 according to an embodiment of the present invention. Demodulation logic 410 may have a similar configuration of the receiver 310 shown in FIG. 3. For example, demodulation logic 410 may include a demodulator, a descrambler, a control CPU, a memory unit that comprises RAM and/or ROM, a host interface, and a control interface unit; the functions of those elements have been described in details in the sections above and won't be repeated herein for brevity. The demodulator logic 410 may further include system-on-a chip infrastructure such as registers, IO ports, an host interface, an external memory interface link 420, which may be similar to the external memory interface port 368 shown in FIG. 3 and described above. In an embodiment, remote or external Flash memory 480 may be coupled to the demodulator SOC 400 through the interface link 420. The coupling can be by means of a physical connection such as a SD card connector or a USB connector. In another embodiment, the coupling can be by means of an optical (e.g., infrared) or radio wave (e.g., Bluetooth, wireless LAN IEEE802.11, or the like) communication link.

In an embodiment, integrated secure element 450 includes a secure CPU 452, a boot read-only memory (ROM) 453, a secure random access memory (RAM) 455, multiple non-volatile memory registers (or fuse banks) 460. In an embodiment, the non-volatile memory registers are implemented using fuse cells that can be fabricated using standard CMOS processes. In an embodiment, the non-volatile memory registers are programmed (burned or blown) during the silicon manufacturing process to store information such as the device ID, the root public key, and others. Integrated secure element 450 also includes multiple hardware accelerators 456 that can be one or more crypto processors as described above in association with crypto hardware 356 of FIG. 3.

In order to minimize cost, the CA software code is stored in the secure RAM 455 according to an embodiment of the present invention. CA software is understood as instructions, one or more sets of instructions, data files, or executable applications that are provided to the secure CPU 452 for execution. CA software is dynamically downloaded from the remote (external) flash memory 480 to the RAM 455 (“RAM-ware”) during the power cycle of the integrated secure element 450. Because CA software is downloaded from the external Flash memory, it must be first authenticated by the integrated secure element 450. In an embodiment, the secure element operates a protocol to authenticate the RAM-ware using a public key algorithm and a digital certificate (e.g., a unique device ID) that is provided during the manufacturing of the demodulator SOC. In an embodiment, the authentication process can be assisted and accelerated using hardware accelerators 456.

In an embodiment, CA software is received by the demodulator logic from the external memory and transferred to the secure RAM 455 via a demodulator interface circuit 466. In contrast to conventional secure elements that store the CA software code in EEPROM and/or Flash memory, embodiments of the present invention provides a RAM-ware architecture that can be updated easily and securely (e.g., by reading in software codes stored in external memories). Because the RAM-ware architecture does not require EEPROM and/or Flash memory that requires among other things a double poly process or a tunnel oxide process and expensive testing equipment and procedures, the RAM-based architecture of the present invention can be cost effectively produced using standard CMOS processes.

In an embodiment, the integrated secure element produces an attribute based on a digital certificate contained in the received software (now RAM-ware because it is now stored in the secure RAM) and provides the attribute to the demodulator logic for descrambling the received data streams (not shown). In some embodiments, the attribute can be a secure bit pattern or a secure codeword to enable the descrambling process in the demodulator logic 410.

In an embodiment, the integrated secure element 450 is activated when the TV application is enabled by the user. When the TV application is enabled, the demodulator logic causes the boot ROM to execute the boot instructions and activate the integrated secure element. During the boot process, the conditional access (CA) firmware stored in the external flash memory is downloaded to the RAM disposed in the secure element, so that the CPU starts operating.

As described above, the remote Flash memory contains conditional access (CA) executable applications or data files that are dynamically loaded to the RAM 455 disposed in the integrated secure element. In an embodiment, the external memory contains a digital certificate that is generated by the CA vendor or the demodulator SOC device manufacturer and signed with the root private key or a derivative of the root key using public key infrastructure (PKI). In an embodiment, the digital certificate may be unique to each demodulator SOC device and contains a device identification (ID) code. In an embodiment, the same identification code may also be stored in one or more of the non-volatile registers 460. In an embodiment, the non-volatile registers 460 may also store a digital signature of the CA software or CA firmware. In an embodiment, the boot ROM authenticates the CA firmware by means of the digital certificate.

In an embodiment, the secure boot ROM may process the digital certificate as follows: (i) verify that the certificate is authentic and the certificate has been signed by a trusted delegate of the root key owner; (ii) verify that the certificate is intended for the given device by comparing the device ID stored in the secure element NVM (non-volatile memory) registers and the code stored in the certificate to ensure that they match; and (iii) authenticate the firmware by regenerating its signature with the root public key and comparing the result with the value stored in the certificate. Only when the above three steps are successful, the SW that has been downloaded to the secure element RAM is verified and considered to be trustworthy. In an embodiment, the SW code in the external memory may be encrypted. In this case, it is first deciphered by the boot ROM. The SW encryption key (or a derivative) is stored in the secure element NVM registers and used directly by the ROM code.

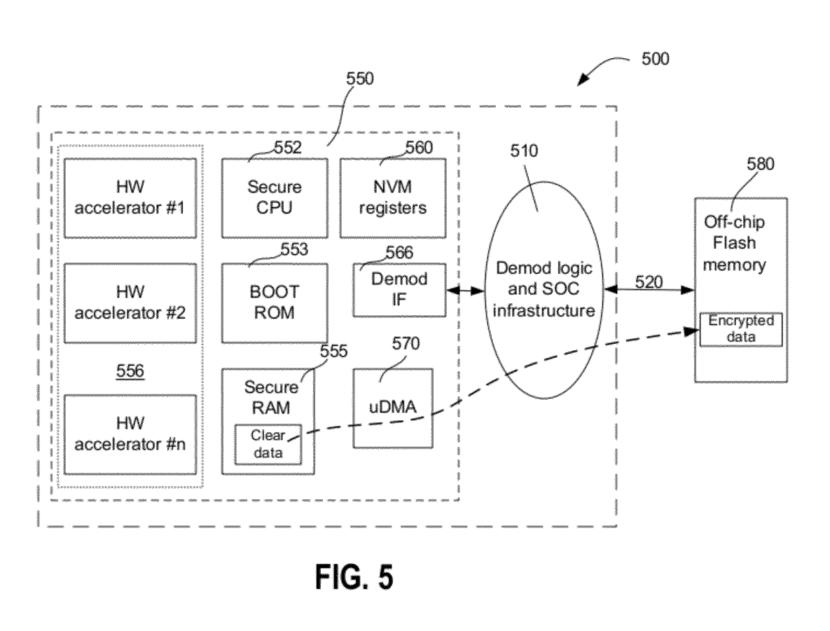

FIG. 5 is a simplified block diagram of an integrated secure element disposed in a demodulator SOC 500 according to an embodiment of the present invention. Demodulator SOC 500 includes a demodulation logic 510 that may have a similar configuration of the receiver 310 shown in FIG. 3. For example, demodulation logic 510 may include a tuner, a demodulator, a descrambler, a control CPU, a memory unit that comprises RAM and/or ROM, a host interface, and a control interface unit; the functions of those elements have been described in details in the sections above and won't be repeated herein for brevity reason. The demodulator logic 510 may further include system-on-a chip infrastructure such as registers, IO ports, one or more direct memory access controllers for interfacing with external storage devices, and other hardware and firmware. In an embodiment, a remote or external Flash memory 580 may be coupled to the demodulator SOC 500 through the demodulator logic 510 by means of a direct memory access controller (DMA) via a communication link 520.

Demodulator SOC 500 also includes an integrated secure element 550 that is coupled to the demodulation logic 510 by means of a demodulator interface 566. In an embodiment, integrated secure element 550 includes a secure CPU 552, a boot read-only memory (ROM) 553 containing a boot code that causes the secure CPU to fetch instruction codes or data (hereinafter data, data files, instruction codes, sets of instructions, executable applications are used alternatively) disposed in the external memory 580 and stores the instruction codes or data in a secure random access memory (RAM) 555. Integrated secure element 550 also includes a plurality of non-volatile memory registers 560 that are implemented using fuse cells that can be fabricated using standard CMOS processes, i.e., without the additional processing steps required for making EEPROM or Flash memory units of conventional secure elements. For example, the non-volatile memory registers are programmed (burned or blown) during the silicon manufacturing process to store information such as the device ID, the root public key, and others. Integrated secure element 550 further includes multiple hardware accelerators 556 that can be one or more crypto processors as described above in association with crypto hardware 356 of FIG. 3.

In accordance with some embodiments of the present invention, CA software, i.e., one or more sets of instructions provided to the secure CPU for execution, is stored in the secure RAM 555 to reduce hardware implementation cost. The CA software is dynamically downloaded from the remote (external) flash memory 580 to the RAM 555 (“RAM-ware”) during the power cycle of the integrated secure element 550. Because the CA software is downloaded from the external Flash memory, it must be first authenticated by the integrated secure element 550. In an embodiment, the secure element operates a protocol to authenticate the RAM-ware using a public key algorithm and a digital certificate that is provided during the manufacturing of the demodulator SOC. In an embodiment, the authentication process can be assisted and accelerated using the hardware accelerators 556.

In an embodiment, CA software is received by the demodulator logic from the external memory and transferred to the secure RAM 555 via a demodulator interface circuit 566. In contrast to conventional secure elements that store the CA software code in on-chip EEPROM and/or Flash memory, embodiments of the present invention provides a RAM-ware architecture that can be updated easily and securely (e.g., by reading in software codes stored in external memories). Because the RAM-ware architecture does not require EEPROM and/or Flash memory, it can be cost effectively produced using standard CMOS processes.

In an embodiment, the integrated secure element produces an attribute based on a digital certificate contained in the received software (now RAM-ware because it is now stored in the secure RAM) and provides the attribute to the demodulator logic for descrambling the received data streams (not shown). In some embodiments, the attribute can be a secure bit pattern or a secure codeword to enable the descrambling process in the demodulator logic 510.

In an embodiment, the integrated secure element 550 is activated when a TV application is enabled by the user. When the TV application is enabled, the demodulator logic 510 causes the boot ROM to execute the boot instructions and activate the integrated secure element. During the boot process, the conditional access (CA) firmware stored in the external flash memory is downloaded to the secure RAM disposed in the secure element 550, so that the secure CPU 552 starts operating.

As described above, the remote Flash memory contains conditional access (CA) software or firmware that is dynamically loaded to the RAM 555 disposed in the integrated secure element. In an embodiment, the external memory contains a digital certificate that is generated by the CA vendor or the demodulator SOC device manufacturer and signed with the root private key or a derivative of the root key using public key infrastructure (PKI). In an embodiment, the digital certificate may be unique to each demodulator SOC device and contains a device identification (ID) code. In an embodiment, the same identification code may also be stored in one or more of the non-volatile memory registers 560. In an embodiment, the non-volatile memory registers 560 may also store a digital signature of the CA software or CA firmware. In an embodiment, the boot ROM authenticates the firmware using the digital certificate.

In an embodiment, the secure boot ROM may process the digital certificate as follows: (i) verify that the certificate is authentic and the certificate has been signed by a trusted delegate of the root key owner; (ii) verify that the certificate is intended for the given device by comparing the device ID stored in the secure element NVM (non-volatile memory) registers and the code stored in the certificate to ensure that they match; and (iii) authenticate the firmware by regenerating its signature with the root public key and comparing the result with the value stored in the certificate. Only when the above three steps are successful, the SW that has been downloaded to the secure element RAM is verified and considered to be trustworthy. In an embodiment, the SW code in the external memory may be encrypted for confidentiality. In this case, it is first deciphered by the boot ROM. The SW encryption key (or a derivative) is stored in the secure element NVM registers and used directly by the ROM code.

In accordance with some embodiments of the present invention, as shown in FIG. 5, external flash memory 580 is used to back up (copy) the data stored in the secure RAM during the execution of the CA SW. The backup operation may be triggered in response to any number of events, such as (i) when recurring timers force a periodic backup; (ii) when a specific data set is modified, based, for example, on the secure firmware state-machine and key provisioning; or (iii) upon a power-off cycle when an off condition is detected or requested by the host. In other embodiments, the backup operation can be dynamically user driven or based on other criteria.

Referring to FIG. 5, integrated secure element 550 includes a direct memory access (DMA) controller 570 coupled to secure RAM 555. DMA controller 570 is a hardware feature that enables movement of blocks of data from peripheral to memory, memory to peripheral, or memory to memory with minimal involving of the secure CPU. In an embodiment, the DMA controller can also be used to move data in parallel with the CPU. In some embodiments, the DMA controller retrieves the clear data stored in the secure RAM and writes it to an external memory port that can reside in the integrated secure element (shown as external memory interface 368 in FIG. 3, memory port interface 420 in FIG. 4, or communication link 520 in FIG. 5). The DMA controller manages the flow of data in and out of the secure element 550. In some embodiments, the DMA controller operations can be performed by secure CPU 552.

In an embodiment, the clear data stored in the secure RAM is encrypted using an encryption key before being backing up. The encryption key can be from a private key security system, where the integrated secure element 550 and the external memory 580 share a “private” key for encrypting and decrypting data passing between them. In an embodiment, the encryption key can be from a public key system, where the secure element has a key pair that consists of a private key and a public key, wherein both keys are used to encrypt and decrypt data, and the private key is only known to the integrated secure element, and the public key is available to many other devices.

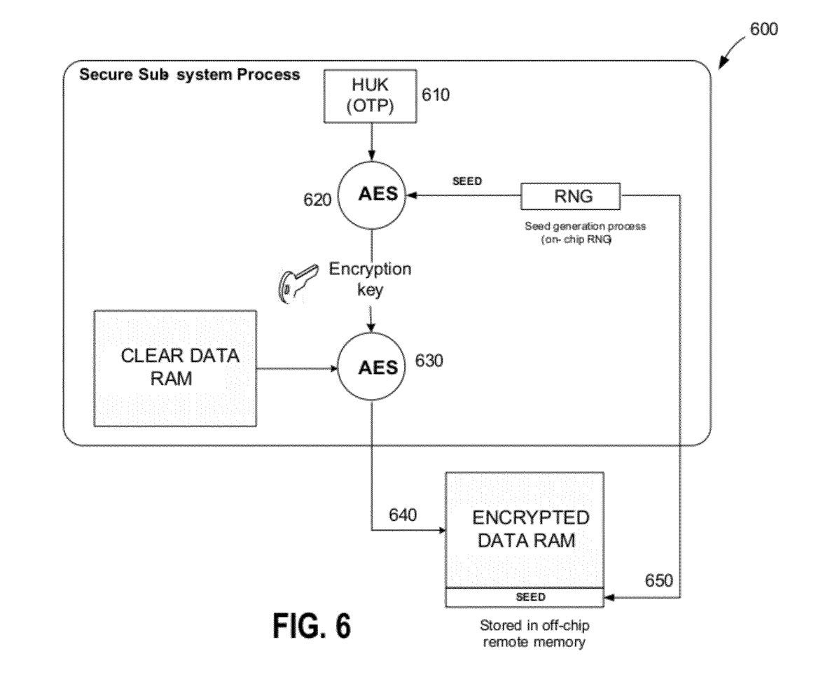

FIG. 6 is an exemplary process 600 for generating an encryption key and for outputting encrypted data to an external memory according to an embodiment of the present invention. At step 610, a hardware unique key (HUK) that is stored in one of the non-volatile memory registers is provided to an AES circuit. The AES circuit can be one of the HW accelerators 556 performing known encryption algorithms, such as DES/3DES, RSA, SHA hashing algorithms, and others. At step 620, the AES circuit processes the HW unique key with a seed, which can be a random number. The seed number, i.e., the random number, can be generated from an on-chip random number generator (e.g., one of the HW accelerators) in an embodiment of the present invention. An encryption key is then generated and provided to a second AES circuit. The second AES processes the clear data stored in the secure RAM with the encryption key at step 630 according to an encryption algorithm and produces encrypted data. In an embodiment, the first AES and second AES circuits can be the same AES circuit. In another embodiment, they may be individual circuits. At step 640, the encrypted data is written to the external memory. In an embodiment, the seed number is also written to the external memory at a predetermined location (step 650).

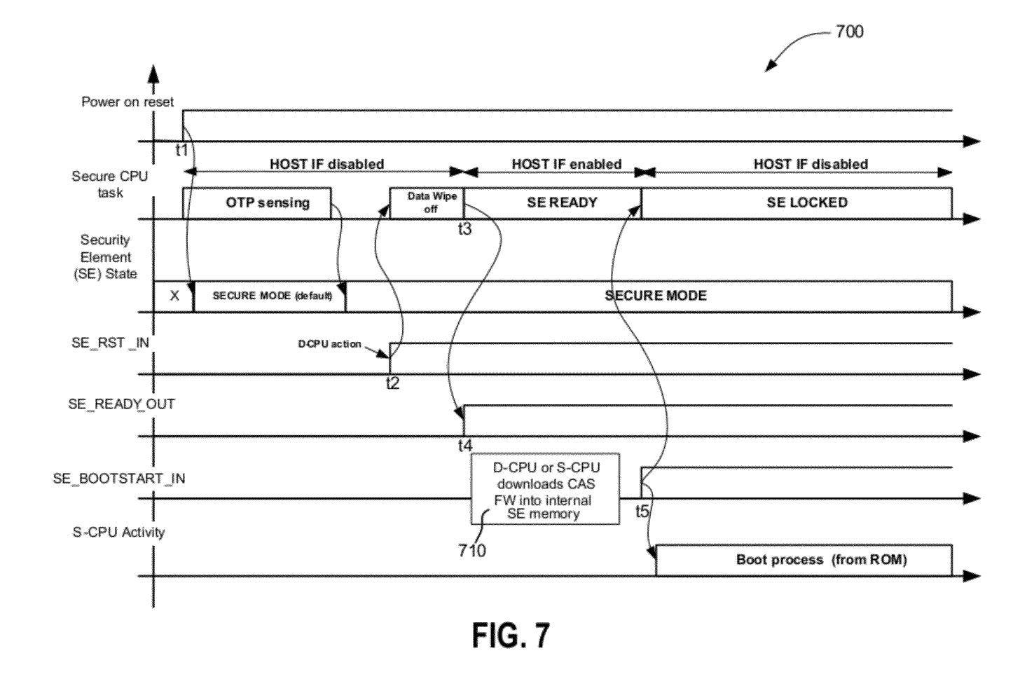

FIG. 7 is a simplified timing diagram illustrating a startup operation 700 of a demodulator SOC according to an embodiment of the present invention. The timing diagram is described with respect to FIG. 4. The boot sequence begins with the application of system power at a time period before t1 where the demodulator SOC remains in a reset mode. When all voltages reach acceptable operating levels, the power supply may send a power-good signal to the demodulator SOC. Upon completion of a power-on-reset at time t1, the secure element is in the default secure mode, and the host interface is disabled. The secure CPU updates the working registers with values stored in associated non-volatile memory registers (indicated as OTP sensing in FIG. 7). The integrated secure element is in the secure mode (the default mode). At time t2, the power-on-reset deassertion of the secure element takes place to set the demodulator in action (indicated by going high at “D-CPU action”) and the demodulator D-CPU initiates the data wipe off of the secure RAM. At time t3, upon the wipe-clean of the secure memory (i.e., setting the RAM content to all “0” or “1”), the secure element signals to the demodulator that the secure memory is ready for data download, the host interface is also enabled at that time, the secure element signals its readiness by outputting a SECREADY_OUT (going high at time t4). The download process (i.e., fetching of CAS firmware from external memory) may start and the firewall, it present, is open to allow data download from an external memory. Upon the download completion, the secure CPU can start the boot-up process at time t5, the secure element is now locked, the firewall, if present, is locked, and the host interface is disabled while the secure element initiates the boot process by means of the boot ROM (this boot process is indicated in the last row in FIG. 7). This diagram is merely an example, which should not unduly limit the scope of the claims. One of ordinary skill in the art would recognize many variations, alternatives, and modifications. For example, FIG. 7 shows that the demodulator D-CPU reads data of the remote (external) Flash memory and writes to the on-chip secure memory (indicated as a box 710). In an alternative embodiment, the secure CPU may reads data from the remote Flash memory and writes the data to the secure memory.

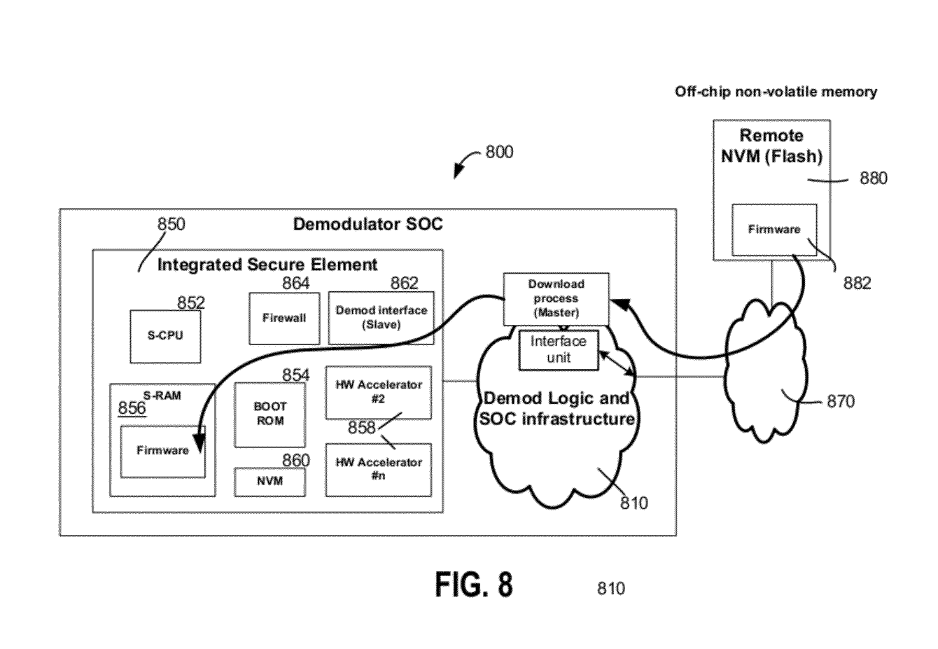

FIG. 8 illustrates a demodulator SOC 800 performing a data download operation from an external memory according to an embodiment of the present invention. Demodulator SOC 800 comprises a demodulator logic 810 and an integrated secure element 850. Demodulator logic 810 may include a tuner, a demodulator, a descrambler, control CPU, a memory unit, a host interface as shown in FIG. 3. The demodulator logic may include SOC infrastructure having IO port, memory interface, and others. In an exemplary embodiment, the SOC infrastructure may include an interface unit 812 such as a USB, a peripheral computer interface (PCI), a SD (secure digital) interface, or a communication link for interfacing with an off-chip non-volatile memory 880. In a specific embodiment, the interface unit 812 may establish a connection to the remote memory via a short distance physical connection via a USB connector, an SD connector, or the like. In another embodiment, the interface unit 812 may coupled to the remote memory 880 via a local area network, a personal area network (Bluetooth) or a wireless area network according to the IEEE802.11 standard or the like (the local, personal, or wireless area network is indicated as a cloud 870).

The integrated secure element includes a secure CPU 852 that together with a boot ROM 854 initiates the integrated secure element at power up. The secure element further includes a secure random access memory (S-RAM) 856, one or more hardware accelerators 858, one or more non-volatile memory (NVM) registers or fuses 860, and a slave demodulator interface circuit 862 that couples the integrated secure element 850 with the demodulator logic 810.

The secure element may include a firewall 864 that allows for the secure CPU to initiate a connection to the remote memory 880 and download firwware (i.e., data, executable applications) 882 from the remote memory to the secure S-RAM 856, but does not allows the remote memory to initiate a connection in the reverse direction.

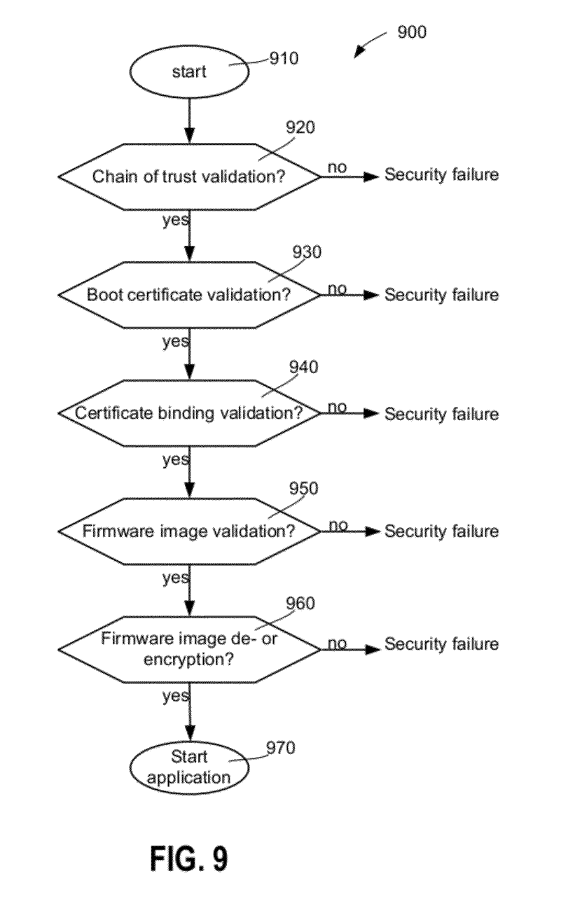

FIG. 9 is a simplified flow chart diagram illustrating a boot loader process 900 according to an embodiment of the present invention. Boot loader process 900 includes a multiple-step sequence and may be implemented in multiple phases. This diagram is merely an example, which should not unduly limit the scope of the claims. One of ordinary skill in the art would recognize many variations, alternatives, and modifications. In a specific embodiment, the boot loader process begins at start (step 910) with the application of power to the demodulator SOC and the subsequent removal of power-on-reset of the various hardware reset configurations as described with regard with the startup operation shown in FIG. 7. The boot ROM as shown in FIG. 8 includes a boot loader so that the secure CPU 852 can subsequently perform a boot sequence on its own once the firmware is written into the secure RAM. As described above, the firmware can be downloaded using the interface unit 812 that may include asynchronous or synchronous memory interface such as SRAM, PSRAM, or DRAM interface. In an embodiment, the asynchronous or synchronous memory interface may couple with a variety of peripherals, such as Ethernet, SD (secure digital) card or MMC (multimedia card), a USB or a wireless connection. Upon the completion of the copying of the firmware from the remote memory 880 to the secure memory 856, the integrated secure element starts a series of validations that includes a chain of trust validation at step 920, a boot certificate validation (step 930), a certificate binding validation (step 940), a firmware image validation (step 950), and a firmware image validation (960). In the event that secure element completes the series of validations successfully, the firmware is considered valid, the secure element will switch execution control to the secure S-RAM 856 and begins the executable applications stored in the S-RAM (step 970). In the event that the validation is unsuccessful, the content of the secure S-RAM may be flushed and the operation is terminated (indicated by the “no” in each validation shown in FIG. 9).

In an alternative embodiment, the boot loader process authenticates the firmware from the external memory prior to writing the firmware to the secure S-RAM. The authentication may be performed using a public key infrastructure (PKI) and digital certificates. The boot process authenticates the digital certificate and bind the public key to the device. The boot process may also decipher the firmware if it is encrypted.

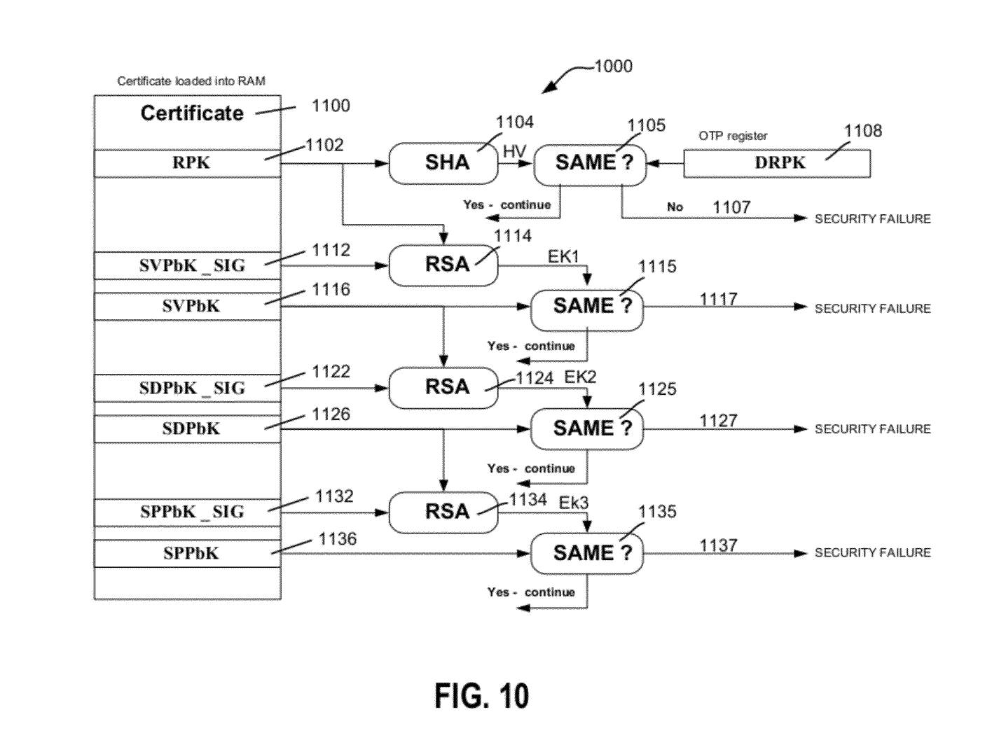

FIG. 10 is a an exemplary diagram illustrating a chain of trust validation 1000 having four-layer RSA public/private keys according to an embodiment of the present invention. In an embodiment, a certificate 1100 that is to be loaded to the secure S-RAM includes a root public key 1102. The secure element performs a hash algorithm 1104 on the root public key to obtain a hash value HV and compare (1105) the obtained hash value HV with a digest root public key (or full key) 1108 that is stored in a non-volatile memory register (shown as NVM block 860 in FIG. 8). If the validation is negative, the secure element will stop the chain of trust validation (1107). If the comparison is positive, the chain of trust validation continue to a first RSA operation 1114. First RSA operation 1114 performs a first RSA algorithm on the root public key RPK 1102 and a software vendor public key signature SVPbK_SIG 1112 to obtain a first RSA value EK1 and compares (operation 1115) the RSA value EK1 with a software vendor key SVPbK 1116. If the comparison is negative (1117), the secure element stops the validation operation. If the comparison 1115 is positive, the secure element will continue a second RSA operation 1124. Second RSA operation 1124 performs a second RSA algorithm 1124 on the software distribution public key SVPbK 1116 and a software distribution public key signature SDPbK_SIG 1122 to obtain a second RSA value EK2 and compares (operation 1125) the second RSA value EK2 with a software distribution public key SDPbK 1126. If the comparison is negative (1127), the secure element stops the validation operation. If the comparison 1125 is positive, the secure element continues to perform a third RSA operation 1134. Third RSA operation 1134 perform a third RSA algorithm 1134 on the software distribution public key SDPbK 1126 and a software personalization site key signature SPPbK SIG 1132 to obtain a third RSA value EK3 and compares the third RSA value EK3 with a software personalization public key SPPbK 1136. If the result of the comparison is negative (1137), the secure element stops the chain of trust validation. If the result of the comparison is positive, the secure element will continue to the boot certificate validation.

For the purposes of the present invention, root public key RPK 1102 is at the highest level in the boot loader process. All other keys are derived and signed from the root public key. The digest of the root public key DRPK or full key 1108 is stored in the OTP (onr time programmable memory, i.e., the non-volatile memory register 860 of FIG. 8) or hardcoded in hardware. Software vendor key SVPbK 1116 is a dedicated CAS software vendor key, where vendor may refer to a network operator, device manufacturer, or other entity that may want to use the demodulator SOC. Software distribution key SDPbK 1126 is a sub-key offered for flexibility of the software signing process to further discriminate the distribution channels (e.g., by region, by customers, by volume, etc.). Software personalization site SPPbK 1136 is a sub-key to identify the physical personalization site or machine used to package the main certificates and firmware. Each sub-key is associated with a digital signature that is the corresponding public key encrypted with the higher level private key (e.g., SVPbK_SIG is the RSA result of SVPbK and RPK). It is understood that the certificate 1100 and the root public key 1102, software vendor public key code (or signature) 1112, software public key 1116, software distribution public key code 1122, software distribution public key 1126, software personalization site code 1132, and software personalization public key 1136 are part of the data and executable codes or applications that need to be loaded to the secure S-RAM.

The chain of trust validation provides numerous security benefits such as verifying that all sub-keys can be verified against the digest root public key (or full key) stored in the non-volatile memory or tamper-proof register of the demodulator SOC device. The other benefits include establishing a root of trust between the software personalization site public key in the certificate and the device: The certificate loaded in the secure memory belongs to the same chain of trust as the hardware device itself.

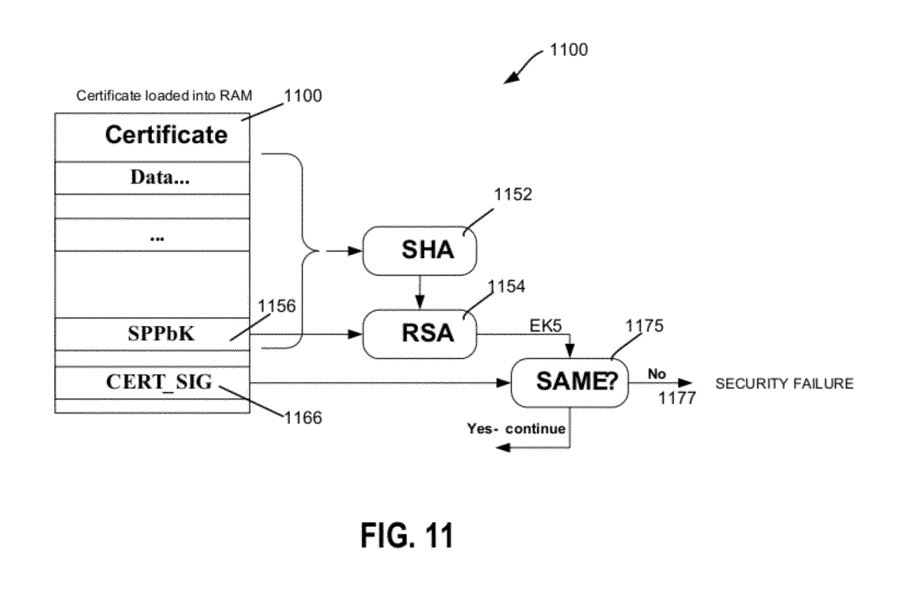

FIG. 11 is a diagram illustrating a boot certificate validation 1100 according to an embodiment of the present invention. Boot certificate validation 1100 verifies that the certificate content can be trusted and has not been altered and establishes a legitimate relationship between the content and the software personalization site public key. Boot certificate validation 1100 comprises hashing (1152) the certificate 1100 including the software personalization site private key SPPvK 1156 to obtain a has value HV1 and performing an RSA function 1154 on the HV1 and the software personalization private key SPPvK 1156 to generate an RSA value EK5. Boot certificate validation 1100 further includes verifying the certificate content by comparing (1176) the RSA value EK5 with a certificate signature CERT SIG 1166. If the comparison is negative (1177), the secure element stops the boot loader process. If the comparison 1175 is positive, the secure element continues to step 940 of the boot loader process, which is the certificate binding validation.

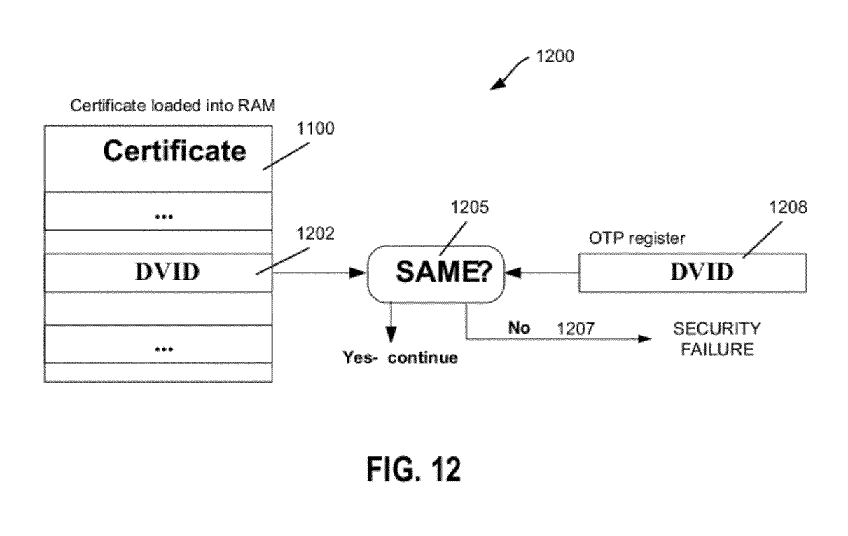

FIG. 12 is a diagram illustrating a certificate binding validation 1200 according to an embodiment of the present invention. Certificate binding validation 1200 verifies that the loaded certificate is intended for the given device and has not been duplicated or copied on another hardware platform. Certificate binding validation 1200 includes comparing the device identification DVID 1208 stored in the OTP or tamper-proof register (NVM register 860 of FIG. 8) with a value 1202 stored in the digital certificate 1100 that has been verified for authenticity in previously validations. If the result of the comparison is negative (1207), the secure element stops the boot loader process. If the comparison 1205 is positive, the secure element continues to step 950 of the boot loader process, which is the firmware image validation.

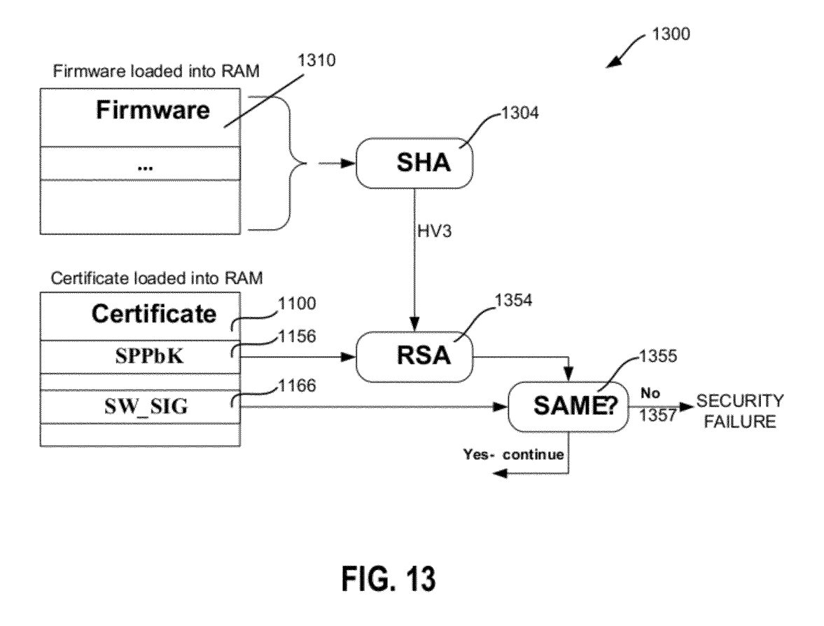

FIG. 13 is a diagram illustrating a firmware image validation 1300 according to an embodiment of the present invention. Firmware image validation 1300 verifies that the entire firmware image has not been altered and is issued from the same chain of trust as the boot certificate. Firmware image validation 1300 is similar to the boot certificate validation performed in step 930. The secure element performs a hash algorithm 1304 on the firmware 1310 to obtain a hash value HV3. The secure element further perform an RSA operation on the obtained hash value HV3 and the software personalization site PPPbk 1156 to generate an RSA value EK13. The generated RSA value EK13 is then compared (1355) with the obtained hash value HV3. If the result of the comparison is negative, the secure element will stop the boot loader process (1357). If the result of the comparison is positive, the secure element will continue the boot loader process at step 960, which is firmware image decryption.

In some embodiments, firmware may be encrypted for confidentiality requirements. The secure element may use one of the following encryption/decryption methods for deciphering firmware: 1) using a symmetric encryption of a software encryption key that is generated from the hardware unique key, which is stored in one of the NVM registers, or 2) and using an asymmetric encryption of a software encryption key with a private/public key pair for which the private key is stored in one of the NVM registers and the public key is used for encryption of the software encryption key that is stored in the digital certificate.

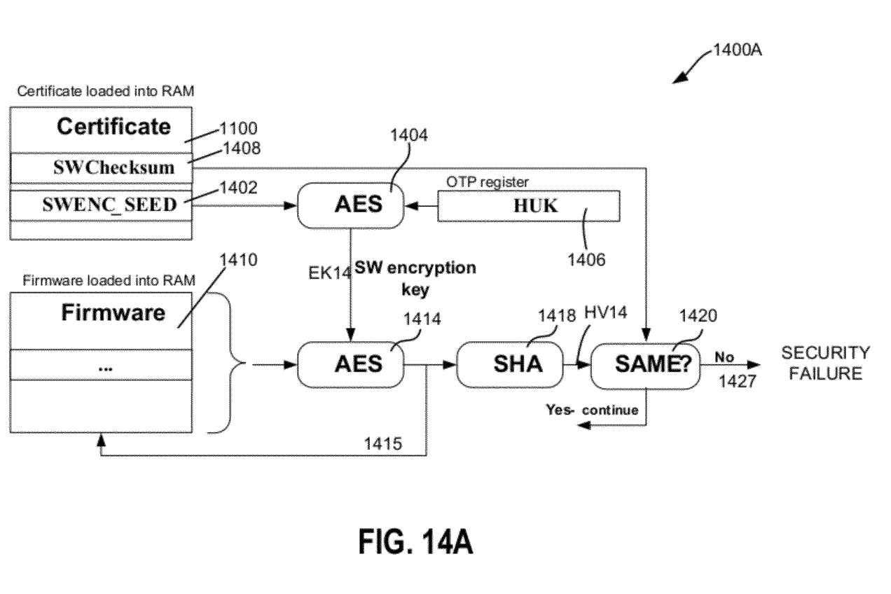

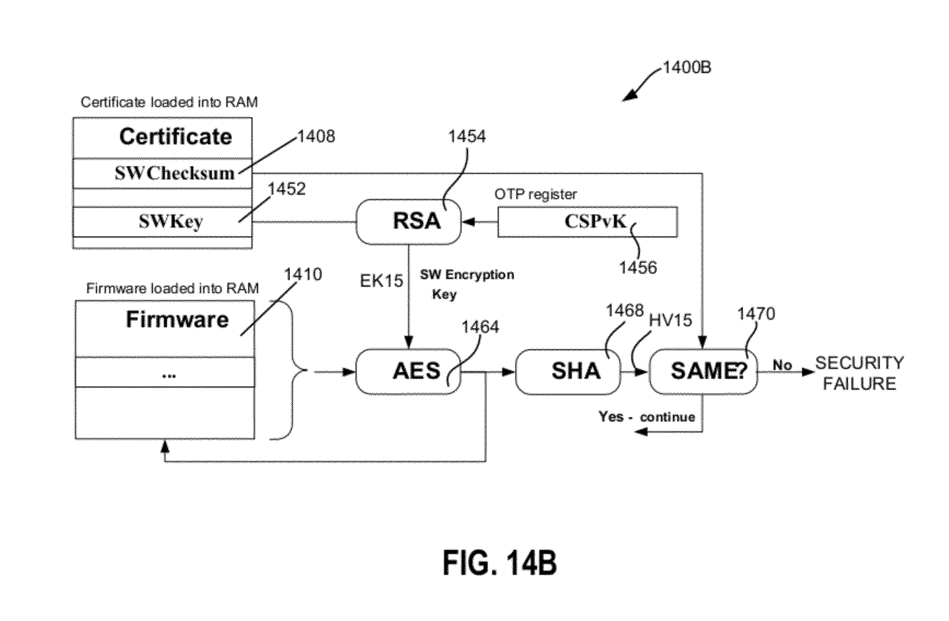

FIG. 14A is a diagram illustrating a firmware image decryption (deciphering) 1400A according to an embodiment of the present invention. The secure element performs a symmetric key encryption using an AES algorithm (advanced encryption standard) 1404 on a software encoded seed value 1402 (which is embedded in the digital certificate 1100) and a hardware unique key 1406 (which is stored in one of the fuse banks, NVM or OTP registers 860 of FIG. 8). The generated software encryption key EK14 is used in a second AES 1414 to decrypt encrypted firmware 1410. The decrypted firmware 1415 is then stored in the secure memory. The decrypted firmware is provided to a hash operation 1418 to generate a hash value HV14 that is compared with a software checksum 1408 embedded in the digital certificate 1100. If the result of the comparison 1420 is negative, the secure element will abort the boot loader process. If the result of the comparison is positive, the secure element starts the applications at step 970.

FIG. 14B is a diagram illustrating a firmware image decryption (deciphering) 1400B according to an alternative embodiment of the present invention. The secure element performs an RSA operation on the software key SWkey1452 and a private key CSPvK 1456 stored in the NVM or OTP register. The generated software encrypted key EK115 is then used in an AES 1464 to decrypt the firmware 1410. The decrypted firmware is stored in the secure S-RAM and also provided to a hash operator 1468 to obtain a hash value HV15. The obtained hash value HV15 is compared with the software checksum 1408. If the result of the comparison 1470 is negative, the secure element will abort the boot loader process. If the result of the comparison is positive, the secure element starts the applications at step 970.

The foregoing description of the code download and boot loader process is not intended to be exhaustive and to limit the scope of the invention to the precise disclosed order and form. For example, although the boot loader process has been described having several sequential steps of validations and firmware image decryption as the last step after the validation. The boot loader process may begins with decryption of the firmware in an embodiment. The boot loader process may also perform in parallel instead of sequentially.

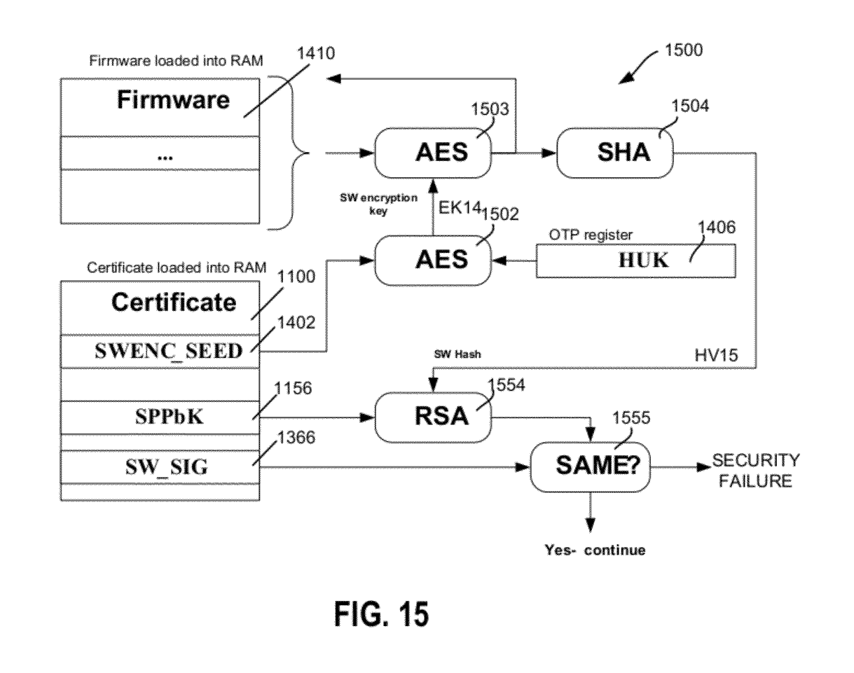

FIG. 15 is a diagram illustrating a one-step firmware decryption and authentication process 1500 according to an embodiment of the present invention. The one-step firmware decryption and authentication process includes a first AES algorithm 1502 that can be performed for example by one of the hardware accelerators 858. AES 1502 generates software encryption key EK14 from SWENC_SEED 1402 and HUK 1406. The software encryption key EK14 is then provided to a second AES 1503 that uses the encryption key EK14 to decipher firmware 1410. The deciphered or decrypted firmware is then hashed to obtain a hash value HV15. An RSA engine 1554 (e.g., one of the hardware accelerators 858) operates on the hash value HV15 and a software personalization site key SPPbK 1156 to produce an RSA value EK20 that is compared with a software signature SW_SIG 1266. In the event that the comparison 1555 produces a match, the secure element starts the applications. In the event that the comparison is negative, the secure element stops the authentication process and may flush the decrypted data or applications files stored in the secure memory.

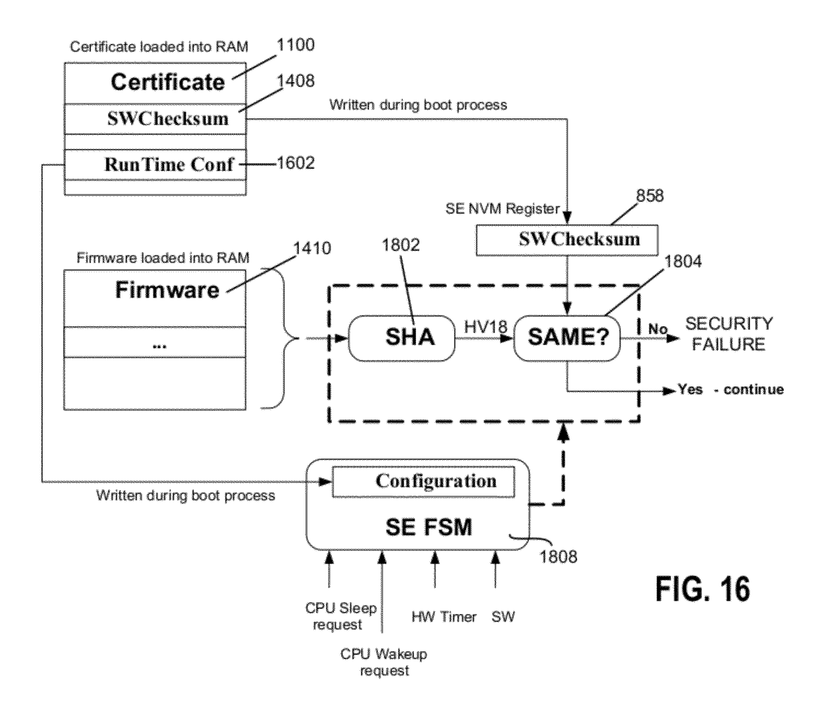

FIG. 16 is a diagram illustrating a firmware run-time authentication using hardware facilities provided by the secure element according to an embodiment of the present invention. The firmware run-time authentication provides an efficient way to mitigate the risk of running malicious code at run time. The firmware run-time authentication verifies and authenticates software within power cycles to protect hardware intrusive attacks and fault injection. In an embodiment, the hardware facilities of the secure element writes (programs by burning or blowing fuses) a software checksum SWChecksum 1408 to one or more of the NVM registers 858 during the boot process and writes runtime configuration parameter to corresponding configuration registers of the secure element finite state machine 1808, which controls the cryptographic hash function 1802 and the comparator 1804. Cryptographic hash function produces a hash value HV18 from firmware 1410 and compares (1804) the hash value HV18 with the SWChecksum stored in one of the NVM registers 858. In the event that there is a match (indicated as “Yes”), the secure element continues its operation. In the event there is no match (indicated as “No”), i.e., the firmware may have been modified or compromised, the secure element disables the firmware execution. In some embodiments, the firmware run-time authentication can be triggered from different sources such as: 1) software driven by requesting an authentication through a control register in the security element; 2) hardware timer as a recurring event driven by a hardware counter set during the boot process; or 3) when the secure S-CPU enters or exits a sleep period.

In an embodiment, the hash value of the decrypted firmware is stored in the boot certificate and is programmed into one of the NVM (one-time-programmable) registers in the secure element during the boot process so that it cannot be modified or altered. It is important to note that this process cannot be performed by the RAM-ware itself because the RAM-ware can be tampered with, Thus, the process has to be performed entirely in hardware or using code stored in ROM that cannot be modified. The SWchechsum written into a write-one-time only register can be reset on power-on/off of the secure element. In addition, the secure element includes control parameters that define the source and recurrence of the run-time check.

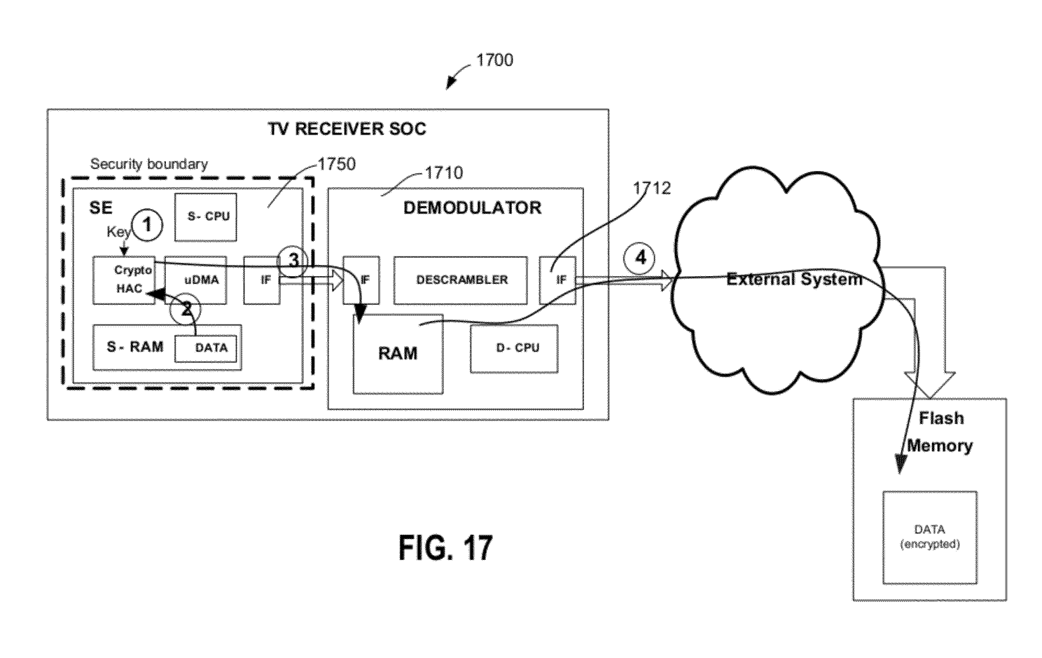

FIG. 17 is a simplified block diagram of a demodulator SOC 1700 (e.g., a TV receiver SOC) illustrating an exemplary data backup operation according to an embodiment of the present invention. Demodulator SOC 1700 includes a demodulator 1710 and an integrated secure element 1750. Upon detecting a backup condition, the integrated secure element generates a data encryption key (indicated as “key” next to step 1 in FIG. 8) from a HW unique key HUK and a seed number, which is a random number generated by one of the HW accelerators. At step 2, the DMA or micro DMA controller reads data stored in the secure RAM and provides the data to a crypto processor (i.e., one of the HW accelerators), which encrypts the data using the generated data encryption key. In an embodiment, a data buffer hash value is also generated and encrypted. The hash value may be used as a checksum during the data retrieval process. At step 3, the DMA controller pushes the encrypted data to the demodulator sub-system RAM through the demodulator interface. At step 4, the demodulator writes the encrypted data to an external memory. In an embodiment, the writing of the encrypted data to the external memory uses an interface unit 1712 that is the same interface unit 812 used for fetching of data from the remote memory as shown in FIG. 8. The data backup process has been described in detail in the U.S. application Ser. No. 13/026,000, filed Feb. 11, 2011, entitled “RAM Based Security Element for Embedded Applications,” the content of which is incorporated herein by reference in its entirety.

The invention is not limited to a specific type of digital broadcast signals as the multiple hardware accelerators can assist CPU to process a specific type of digital signal. The CPU may include suitable logic, circuitry and program code for performing conditional access operations, detection of backup conditions, and others. In an embodiment, the CPU may be configured to process a specific conditional access to a service provider. The random access memory may store new conditional access operations that are either specific to a service provider or content owner. In an embodiment, the boot ROM may load and store code and data to perform conditional access operations. In an embodiment, the non-volatile memory registers include one or more fuse banks or fuse registers to store information for authentication and device specific identification (ID). In another embodiment, the hardware accelerators may include one or more AES circuits to generate an encryption key and/or perform data encryption.

Many alternatives, modifications, and variations will be apparent to those skilled in the art in light of the above teachings. For example, although embodiments of the present invention are described in relation to a handheld receiver device for digital TV, they can also be applied to portable receivers such as laptop computers, notebooks, tablets and other mobile devices such as car receivers for receiving digital audio broadcastings or other controlled broadcasting standards. Embodiments of the present invention can also apply to networked devices.

It is understood that the above embodiments of the present invention are illustrative and not limitative. Various alternatives and equivalents are possible. The invention is not limited by the type of integrated circuits in which the present disclosure may be disposed. Other additions, subtractions or modifications are obvious in view of the present invention and are intended to fall within the scope of the appended claims.

What is claimed is:

1. An integrated circuit comprising:
a demodulator for receiving an encrypted content;
an interface unit adapted to communicate with an external memory; and
a hardware unit communicatively coupled to the demodulator, the hardware unit comprising:
a processing unit;
a read-only access memory comprising a boot code adapted to cause the integrated circuit to fetch executable applications from the external memory;
a random access memory adapted to store the fetched executable applications and provide the stored executable applications to the processing unit for execution;
a plurality of non-volatile memory registers or fuse banks configured to store at least one unique identifier; and
a plurality of hardware accelerators.

2. The integrated circuit of claim 1, wherein the external memory comprises a non-volatile memory.

3. The integrated circuit of claim 1, wherein the interface unit comprises a wired or wireless communication link.

4. The integrated circuit of claim 1, wherein the boot code comprises executable instructions configured to perform a series of validations to the fetched executable applications.

5. The integrated circuit of claim 4, wherein the series of validations comprises at least one of a chain of trust verification, a boot certificate validation, a certificate binding validation, and a firmware image validation.

6. The integrated circuit of claim 5, wherein the chain of trust verification comprises a mechanism configured to hash a root public key for obtaining a hashed value and compare the obtained hashed value with the at least one unique identifier.

7. The integrated circuit of claim 1, wherein the at least one unique identifier comprises a digest boot root public key.

8. The integrated circuit of claim 1 further comprising a firewall unit configured to enable the hardware unit to originate a communication via the interface module to the external memory, but does not allow the external memory to initiate a connection to the hardware unit.

9. The integrated circuit of claim 1, wherein the at least one unique identifier comprises 128 least significant bits (LSB) of a SHA hash of a digest key or a full key.

10. The integrated circuit of claim 1, wherein at least one of the plurality of hardware accelerators performs a hashing function on a portion of the executable applications to generate a signature and compare the generated signature with the at least one unique identifier.

11. The integrated circuit of claim 10, wherein the integrated circuit disables the executable applications in the event that the generated signature and the at least one unique identifier do not match.

12. The integrated circuit of claim 1, wherein boot code comprises instructions to cause the hardware unit to authenticate the executable applications at run-time, prior to initiating the executable applications.

13. The integrated circuit of claim 1, wherein the executable applications comprise:
a digital certificate including a signature and run-time configuration parameters; and
one or more computer programs.

14. The integrated circuit of claim 13, wherein the hardware unit writes the signature to one of the plurality of non-volatile memory registers, inputs the run-time configuration parameters to the processing unit, and causes the processing unit to authenticate the one or more computer programs.

15. The integrated circuit of claim 14, wherein the processing unit authenticates the one or more computer programs by computing a hash value of the one or more computer programs and comparing the computed hash value with the signature.

16. A CMOS device being fabricated using standard CMOS processes without on-chip EEPROM and/or Flash memory units, the CMOS device comprising:
an interface module for fetching secure data from a memory that is external to the CMOS device;
a random access memory unit being integrated on the CMOS device and configured to store the fetched secure data; and
a read-only-memory unit having a boot code that is configured to cause the CMOS device to authenticate the stored secure data based on a series of validations.

17. The CMOS device of claim 16 further comprising:
a first logic unit configured to perform a hash algorithm on a root public key contained in the secure data to generated a hash value and compare the generated hash value with a digest boot root public key stored in the CMOS device.

18. The CMOS device of claim 16 further comprising:
a second logic unit configured to perform a public-private key encryption algorithm on a root public key and an encryption signature to generate an encryption key and compare the generated encryption key against a public encryption key, wherein the root public key, the encryption code and the public encryption key are contained in the fetched secure data.

19. The CMOS device of claim 16 further comprising:
a first mechanism configured to flush the secure data stored in the random access memory if the CMOS device fails to successfully complete the series of validations.

20. The CMOS device of claim 16 further comprising:
a second mechanism configured to cause the CMOS device to encrypt the secure data stored in the random access memory and write the encrypted secure data to an external flush memory device in response to a backup event.

21. The CMOS device of claim 16, wherein the series of validation comprises at least one of a chain of trust validation, a boot certificate validation, a certificate binding validation, a firmware image validation, and a firmware image decryption or encryption.

22. The CMOS device of claim 16, wherein the interface module comprises a wired connection or a wireless connection.

23. A method for authenticating data from an external memory that is to be stored into a device having random access memory unit and a read only memory unit, wherein the read only memory unit includes a boot code that causes the device to fetch the data from the external memory, the method comprising:
fetching data from the external memory;
storing the fetched data in the random access memory unit; and
authenticating the fetched data based on a series of validation;
wherein the fetched data comprises one or more executable applications and a certificate including at least a root public key.

24. The method of claim 23 further comprising:
comparing a portion or an entirety of an obtained hash value with a digest boot root public key or a full key that is stored in a non-volatile memory register of the device.

25. The method of claim 23 further comprising:
performing a public-private key encryption algorithm on the root public key and an encryption signature embedded in the certificate to obtain a RSA value; and
comparing the obtained RSA value with an encryption key that is included in the certificate.

26. The method of claim 23, wherein the device comprises a CMOS integrated circuit including:
a random access memory unit configured to stored the fetched data; and
a plurality of non-volatile memory registers or fuse banks configured to store at least a unique identification code;
wherein the CMOS integrated circuit is fabricated using standard CMOS processes and does not comprises on-chip EEPROM and/or Flash memory units.

27. The method of claim 26, wherein the CMOS integrated circuit comprises a mechanism to encrypt the data stored in the random access memory and write the encrypted data to an external storage device in response to a backup event.

28. The method of claim 27, wherein the external storage device comprises an Flash memory device.

29. The method of claim 23, wherein the series of validations comprises at least one of a chain of trust validation, a boot certificate validation, a certificate binding validation, a firmware image validation, and a firmware image decryption or encryption.

30. The method of claim 23 further comprising:
flushing the data stored in the random access memory if the authenticating of the fetched data is not successful.
